(19) United States
(12) Patent Application Publication
(10) Pub. No.: US 2026/0239201 A1
(43) Pub. Date: Aug. 13, 2026

(54) ENERGY-DEPENDENT PAYLOAD FOR ENERGY HARVESTING COMMUNICATIONS

(71) Applicant: QUALCOMM Incorporated, San Diego, CA (US)

(72) Inventors: Michael MITRANI, San Diego, CA (US); Ahmed Abdelaziz Ibrahim Abdelaziz ZEWAIL, San Diego, CA (US); Zhifei FAN, San Diego, CA (US); Chengjin ZHANG, San Diego, CA (US)

(21) Appl. No.: 19/048,152

(22) Filed: Feb. 7, 2025

(51) Int. Cl. H04W 52/02; H02J 50/00; H02J 50/80; H04W 24/08

(52) U.S. Cl. CPC H04W 52/0229; H02J 50/001; H02J 50/80; H04W 24/08

(57) ABSTRACT

Methods, systems, and devices for wireless communications are described. In some examples, a wireless device may obtain energy signaling associated with charging the wireless device in accordance with an energy harvesting operation. The wireless device may, in accordance with the energy signaling and the energy harvesting operation, charge the wireless device according to a charge rate of the wireless device. The charge rate may be based on a location of the wireless device relative to a transmitter of the energy signaling, one or more other parameters associated with the wireless device, or any combination thereof. The wireless device may output a signal in response to the energy signaling and the charging. The reflected signal may include one or more different types of data. The one or more different types of data may be included in the reflected signal in accordance with the charge rate of the wireless device.

### FIELD OF TECHNOLOGY

The following relates to wireless communications, including energy-dependent payload for energy harvesting communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless device is described. The method may include obtaining energy signaling associated with charging the wireless device in accordance with an energy harvesting (EH) operation, charging, in accordance with the energy signaling and the EH operation, the wireless device according to a charge rate of the wireless device, and outputting a signal in response to the energy signaling, where the signal includes one or more different types of data in accordance with the charge rate of the wireless device.

A wireless device for wireless communications is described. The wireless device may include one or more memories storing processor executable code, and one or more processors coupled with the one or more memories. The one or more processors may individually or collectively be operable to execute the code to cause the wireless device to obtain energy signaling associated with charging the wireless device in accordance with an EH operation, charge, in accordance with the energy signaling and the EH operation, the wireless device according to a charge rate of the wireless device, and output a signal in response to the energy signaling, where the signal includes one or more different types of data in accordance with the charge rate of the wireless device.

Another wireless device for wireless communications is described. The wireless device may include means for obtaining energy signaling associated with charging the wireless device in accordance with an EH operation, means for charging, in accordance with the energy signaling and the EH operation, the wireless device according to a charge rate of the wireless device, and means for outputting a signal in response to the energy signaling, where the signal includes one or more different types of data in accordance with the charge rate of the wireless device.

A non-transitory computer-readable medium storing code for wireless communications is described. The code may include instructions executable by one or more processors to obtain energy signaling associated with charging the wireless device in accordance with an EH operation, charge, in accordance with the energy signaling and the EH operation, the wireless device according to a charge rate of the wireless device, and output a signal in response to the energy signaling, where the signal includes one or more different types of data in accordance with the charge rate of the wireless device.

In some examples of the method, wireless devices, and non-transitory computer-readable medium described herein, outputting the signal may include operations, features, means, or instructions for outputting, via one or more first fields of a set of multiple fields included in the signal, a first type of data of the one or more different types of data included in the signal, where the first type of data includes measurement information associated with one or more first components of the wireless device after the charging according to the charge rate and outputting, via one or more second fields of the set of multiple fields in the signal, a second type of data of the one or more different types of data included in the signal, where the second type of data includes dummy data in accordance with a state of one or more second components of the wireless device after the charging according to the charge rate.

Some examples of the method, wireless devices, and non-transitory computer-readable medium described herein may further include operations, features, means, or instructions for activating the one or more first components in accordance with the charge rate of the wireless device and obtaining, by the one or more first components in accordance with the activating, the measurement information, where outputting the first type of data via the signal may be in accordance with obtaining the measurement information.

In some examples of the method, wireless devices, and non-transitory computer-readable medium described herein, outputting the second type of data may include operations, features, means, or instructions for outputting, via the one or more second fields of the set of multiple fields in the signal, one or more bit patterns that indicate the one or more second fields include the dummy data.

In some examples of the method, wireless devices, and non-transitory computer-readable medium described herein, outputting the signal may include operations, features, means, or instructions for outputting, via the signal, an indication of a position of the one or more first fields including the first type of data.

In some examples of the method, wireless devices, and non-transitory computer-readable medium described herein, a length of the signal includes a fixed length irrespective of an amount of data included in the one or more different types of data in the signal, the fixed length including the one or more first fields and the one or more second fields.

In some examples of the method, wireless devices, and non-transitory computer-readable medium described herein, outputting the signal may include operations, features, means, or instructions for outputting, via a header included within the signal, an indication of one or more first fields that may be included in the signal and outputting, via the one or more first fields included in the signal, a first type of data of the one or more different types of data included in the signal, where the first type of data includes measurement information associated with one or more first components of the wireless device after the charging according to the charge rate.

Some examples of the method, wireless devices, and non-transitory computer-readable medium described herein may further include operations, features, means, or instructions for activating the one or more first components in accordance with the charge rate of the wireless device and obtaining, by the one or more first components in accordance with the activating, the measurement information, where outputting the first type of data via the one or more first fields included in the signal may be in accordance with obtaining the measurement information, and where a quantity of data fields included within the signal in accordance with the charge rate.

In some examples of the method, wireless devices, and non-transitory computer-readable medium described herein, the indication of the one or more first fields further indicates an absence of one or more second fields in accordance with one or more second components of the wireless device that may be unpowered after the charging according to the charge rate.

Some examples of the method, wireless devices, and non-transitory computer-readable medium described herein may further include operations, features, means, or instructions for receiving second energy signaling after outputting the signal, where the one or more different types of data included in the signal indicate the charge rate of the wireless device, and where a second transmission power of the second energy signaling may be greater than a first transmission power of the energy signaling based on the charge rate of the wireless device.

Some examples of the method, wireless devices, and non-transitory computer-readable medium described herein may further include operations, features, means, or instructions for measuring, after initiating the charging of the wireless device, a voltage associated with the wireless device in accordance with the energy signaling, initializing a timer in accordance with the measured voltage satisfying a first threshold, and stopping the timer in accordance with the measured voltage satisfying a second threshold, the second threshold corresponding to a threshold transmission voltage for the wireless device, where the charge rate of the wireless device corresponds to an elapsed time of the timer.

In some examples of the method, wireless devices, and non-transitory computer-readable medium described herein, the one or more different types of data include one or more different types of sensor data associated with one or more sense components of the wireless device.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports energy-dependent payload for EH communications in accordance with one or more aspects of the present disclosure.

FIG. 2 shows an example of a wireless communications system that supports energy-dependent payload for EH communications in accordance with one or more aspects of the present disclosure.

FIG. 3 shows examples of message formats that support energy-dependent payload for EH communications in accordance with one or more aspects of the present disclosure.

FIG. 4 shows an example of a process flow that supports energy-dependent payload for EH communications in accordance with one or more aspects of the present disclosure.

FIGS. 5 and 6 show block diagrams of devices that support energy-dependent payload for EH communications in accordance with one or more aspects of the present disclosure.

FIG. 7 shows a block diagram of a communications manager that supports energy-dependent payload for EH communications in accordance with one or more aspects of the present disclosure.

FIG. 8 shows a diagram of a system including a device that supports energy-dependent payload for EH communications in accordance with one or more aspects of the present disclosure.

FIGS. 9 through 11 show flowcharts illustrating methods that support energy-dependent payload for EH communications in accordance with one or more aspects of the present disclosure.

### DETAILED DESCRIPTION

A wireless device (e.g., an energy harvesting (EH) device, or the like) may receive an energy signal from a reader and may harvest at least a portion of the energy of the signal to charge the wireless device. The device may perform one or more functions using the energy, such as transmitting a reflected (e.g., backscattered) signal, performing one or more sensing operations, or both. For example, the device may activate one or more sensors of the device and obtain sensor data using the sensors. The sensor data may be included in the reflected signal. A charge rate of the device may vary according to a location of the device with respect to an entity that transmits the energy signal, a duration of the energy signal, a transmit power of the energy signal, or any combination thereof. A device with a relatively slow charge rate (e.g., a tag at a cell edge) may not charge to a sufficient power level to activate one or more of the device's sensors before sending a response to the energy signal, and may be unable to include accurate sensor data within the backscattered signal, while other devices that charge relatively quickly may support inclusion of sensor data in the response. Accordingly, techniques for adapting reflected signal contents based on charge rates may be beneficial.

The techniques, methods, and devices described herein may support energy-dependent payloads for EH communications. For example, a wireless device may determine a rate at which the wireless device charges and may determine which sensors of the wireless device to activate, which sensor data to include in a reflected signal, or both in accordance with the charge rate and one or more protocols as described herein. The wireless device may determine the charge rate based on determining an elapsed time (e.g., a charging duration of the wireless device) between charging to an initial threshold power level and charging to a final threshold power level during a charging cycle of the wireless device in response to receipt of an energy signal. The wireless device may determine whether to turn on (e.g., activate) one or more components (e.g., sensors, processors, or the like) within the device based on the determined charge rate. The wireless device may obtain sensor data using the activated components and may include the obtained sensor data, if any, in a reflected signal.

The reflected signal may be a fixed-length signal or a variable-length signal. If the response is a fixed-length signal, the wireless device may include sensor data obtained by the components the wireless device was able to turn on with the detected charge rate, and the wireless device may pad remaining fields in the signal with dummy data. If the response is a variable-length response, the device may adjust a length of the response based on how much sensor data the device was able to obtain. The device may transmit an indication via a header of the response to indicate which fields include dummy data, which fields were skipped, or both. A receiving device may use the information in the responsive signal to determine a charging rate of the wireless device and adjust transmission durations and powers for transmission of subsequent energy signals accordingly (e.g., to support more sensor data or less sensor data).

By transmitting the reflected signal according to an energy-dependent payload format, the wireless device may refrain from enabling one or more device components (e.g., measurement components) if the device is not able to fully charge or charges relatively slowly, which may accordingly reduce power consumption. Additionally, or alternatively, by indicating, by the wireless device, which data fields may be included within the reflected signal, a receiving device may determine (e.g., detect or identify) which measurement information may not be included within the reflected signal, which may improve communication reliability and may reduce communication latency, among other examples.

Aspects of the disclosure are initially described in the context of wireless communications systems. Aspects of the disclosure are further described in the context of wireless communications systems, message formats, and process flows. Aspects of the disclosure are further illustrated by and described with reference to apparatus diagrams, system diagrams, and flowcharts that relate to energy-dependent payload for EH communications.

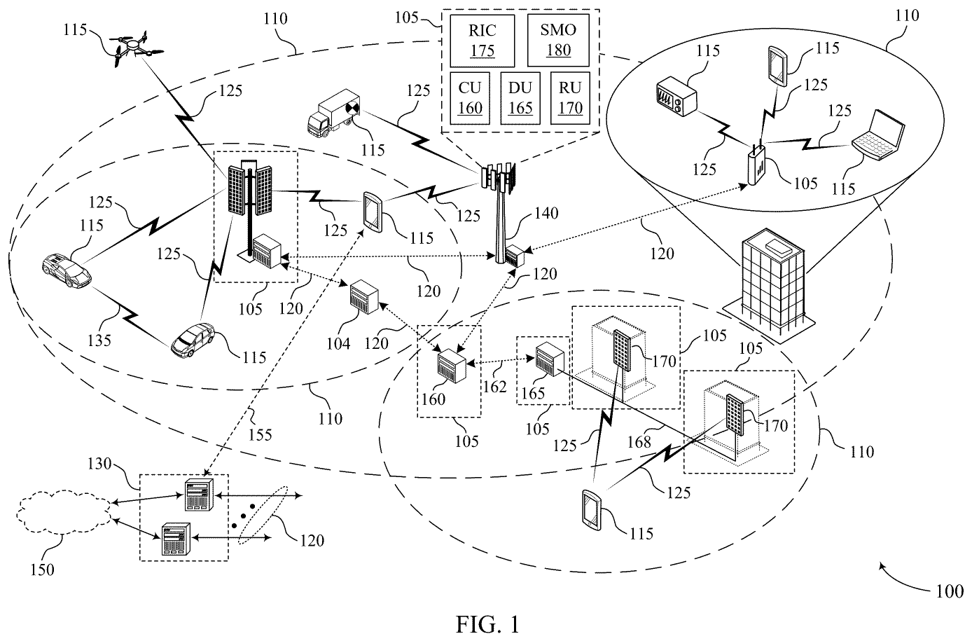

FIG. 1 shows an example of a wireless communications system 100 that supports energy-dependent payload for EH communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support energy-dependent payload for EH communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The techniques, methods, and devices described herein may support energy-dependent payload for EH communications. A wireless device (e.g., a UE 115 or some other wireless device) may determine the charge rate based on determining an elapsed time (e.g., a charging duration of the wireless device) between charging to an initial threshold power level and charging to a final threshold power level during a charging cycle of the wireless device in response to receipt of an energy signal. The wireless device may determine whether to turn on (e.g., activate) one or more components (e.g., sensors, processors, or the like) within the device based on the determined charge rate. The wireless device may obtain sensor data using the activated components and may include the obtained sensor data, if any, in a reflected signal.

The reflected signal may be a fixed-length signal or a variable-length signal. If the response is a fixed-length signal, the wireless device may include sensor data obtained by the components the wireless device was able to turn on with the detected charge rate, and the wireless device may pad remaining fields in the signal with dummy data. If the response is a variable-length response, the device may adjust a length of the response based on how much sensor data the device was able to obtain. The device may transmit an indication via a header of the response to indicate which fields include dummy data, which fields were skipped, or both. A receiving device, which may be referred to as a reader herein and may represent an example of a network entity 105 or some other device, may use the information in the responsive signal to determine a charging rate of the wireless device and adjust transmission durations and powers for transmission of subsequent energy signals accordingly (e.g., to support more sensor data or less sensor data).

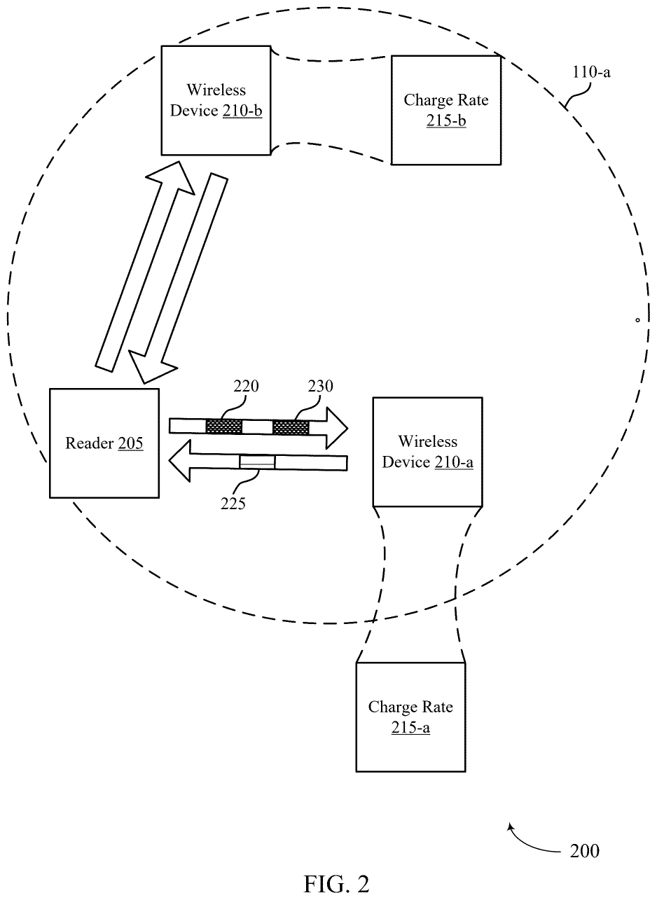

FIG. 2 shows an example of a wireless communications system 200 that supports energy-dependent payload for EH communications payload for EH communications in accordance with one or more aspects of the present disclosure. Aspects of the wireless communications system 200 may implement or be implemented by aspects of the wireless communications system 100. For example, the wireless communications system 200 may include a reader 205, a wireless device 210-a, and a wireless device 210-b, which may be examples of the network entity 105 and a UE 115 (e.g., a reduced capability UE 115), respectively, or the like. The reader 205 may communicate with the wireless device 210-a, the wireless device 210-b, and one or more other devices, within a geographic coverage area 110-a (e.g., a cell), which may represent an example of the geographic coverage areas 110 described with reference to FIG. 1.

In some cases, the wireless communications system 100, the wireless communications system 200, or both may implement radio frequency identification (RFID), which may support various functions including inventory and asset management inside and outside of warehouses, IoT, sustainable sensor networks for factories, agriculture, or smart home features, among other examples. In some cases, devices performing RFID functions may include relatively small transponders (e.g., tags) which may emit an information-bearing signal after receiving a signal (e.g., an initial signal, or energy-bearing signal, among other examples).

RFID devices (e.g., low-power devices) may operate without a battery or with a relatively small battery at a relatively low operating expense (OPEX), low maintenance cost, and a relatively long life cycle, among other examples. In some cases, passive RFID devices may harvest energy over the air (e.g., via harvesting energy from energy-bearing signals) and may power transmission and reception circuitry of the device using the harvested energy. Additionally, or alternatively, the passive RFID device may output a transmitted signal, which may be backscatter modulated. For example, the device may generate and output a reflected signal via backscatter modulation, the device may transmit a data signal such as a data packet, or both, among other examples. Additionally, or alternatively, semi-passive or active RFID devices (e.g., RFID devices including a battery), which may perform additional functionality, may be implemented (e.g., at a relatively higher cost).

Some wireless communication protocols (e.g., 5G technologies or other technologies) may support industrial applications (e.g., besides eMBB, URLLC, and MTC, among other examples). Accordingly, such wireless communication protocols may support passive IoT (e.g., MTC/NB-IoT, reduced capability (RedCap) 5G, or the like) for MTC use cases. As such, a network entity (e.g., a gNB, or the like) may read information, write information, or both stored on passive IoT devices. The network entity may provide energy to the passive IoT devices via one or more energy-bearing signals, and an information-bearing signal may be reflected to network entity by the IoT devices. That is, the network entity may output one or more energy-bearing signals, and the tag devices may correspondingly charge (e.g., based on harvesting the energy of the energy-bearing signals) and output the reflected signals (e.g., reflected or backscattered signals, or transmitted data signals such as one or more data packets, among other examples). The network entity may read the reflected signal to decode the information transmitted by (e.g., stored at, and indicated by) the IoT devices. The reader 205 illustrated in FIG. 2 may represent an example of such a network entity 105, in some examples described herein.

Passive ambient IoT (A-IoT) devices (e.g., tags) may utilize harvested energy to power the tag. In some cases, a charging rate of the tag may vary depending on a location of the tag with respect to the reader 205, a transmitter device different from the reader 205, or both. In some cases, the reader 205 and the transmitter device may be a same component, different components of a common network node (e.g., the network entity 105), or different components corresponding to different (e.g., separate) network nodes, among other examples. That is, nearby by tags may charge at a relatively faster rate, while more distant (e.g., cell-edge, for an example) tags may utilize a relatively longer time to charge. Accordingly, the A-IoT devices may perform multiple rounds of responses such that the reader 205 may decode the information of the tag device. In some scenarios, the A-IoT devices may include a sensing capability, which may include activating one or more sensors, a central processing unit (CPU), or the like such that that the tag device may form (e.g., generate) a response message containing sensed (e.g., measured) information. In such cases, the cell-edge A-IoT devices may have a low charging rate, and may accordingly be unable to power one or more sensors, one or more CPUs, or any combination thereof.

The techniques, methods, and devices described herein may support an energy-dependent payload for EH communications. That is, one or more information-bearing signals (e.g., signals responsive to one or more energy-bearing signals, which may include reflected signals or transmitted data signals, among other examples) may include an adjusted response format. For example, the information-bearing signal (e.g., reflected signal, among other examples) may be a fixed-length signal or a variable-length signal. If the response is a fixed-length signal, the wireless device may include sensor data obtained by the components the wireless device was able to turn on with the detected charge rate, and the wireless device may pad remaining fields in the signal with dummy data. If the response is a variable-length response, the device may adjust a length of the response based on how much sensor data the device was able to obtain

In some implementations, the reader 205 may communicate with multiple wireless devices 210. For example, the reader 205 may communicate with the wireless device 210-a (e.g., an A-IoT device, or tag device, among other examples) and the wireless device 210-b, among other devices. The wireless device 210-a and the wireless device 210-b may each be associated with a respective charge rate 215 (e.g., a rate of charging the device based on receiving energy signaling from the reader 205), where each respective charge rate 215 may correspond to one or more operating parameters of the multiple wireless devices 210, one or more parameters associated with the energy signaling 220, or any combination thereof. For example, the wireless device 210-a may be associated with a charge rate 215-a and the wireless device 210-b may be associated with a charge rate 215-b. In the example of FIG. 2, the wireless device 210-b may be located relatively far from the reader 205 compared to the wireless device 210-a, which may be nearby the reader 205. For example, the wireless device 210-b may be at a cell-edge (e.g., an edge of the geographic coverage area 110-a). Accordingly, the charge rate 215-b of the wireless device 210-b may be relatively slower (e.g., a low charge rate) compared to the charge rate 215-a. That is, the wireless device 210-b may attain a relatively lower charge level (e.g., a lower voltage level) within a same duration based on the charge rate 215-b compared to a charge level of the wireless device 210-a based on the charge rate 215-a. Additionally, or alternatively, the charge rate 215-a and the charge rate 215-b may be different based on one or more different operating conditions, such as a transmission power or a signal duration of respective energy signaling (e.g., energy signaling associated with the wireless device 210-a and the wireless device 210-b respectively), among other examples.

In some examples, the reader 205 may output energy signaling 220, which may include a device-to-reader (D2R) query, among other examples. The wireless device 210-a may, based on obtaining the energy signaling 220, determine a charging rate of the wireless device 210-a. In some examples, the wireless device 210-a may measure a voltage corresponding to a power level of the wireless device 210-a. A starting voltage of the wireless device 210-a (e.g., a first-measured voltage) before the energy signaling 220 is received may be lower (e.g., 0 volts (V), among other examples) than an initial voltage associated with determining the charge rate of the wireless device 210-a. The voltage of the wireless device 210-a may increase based on harvesting energy of the energy signaling 220, and, in some examples, a measured value of the voltage may satisfy (e.g., equal) a threshold corresponding to the initial voltage (e.g., 0.6 V, among other examples). Accordingly, the wireless device 210-a may start (e.g., initialize) a low-power clock, a low-power timer, or a low-power counter, among other examples. The wireless device 210-a may stop the clock, timer, or counter after the measured value of the voltage satisfies (e.g., equals or exceeds) a threshold voltage associated with transmitting a response message to the energy signaling 220 wireless device 210-a. Accordingly, the wireless device 210-a may determine the charge rate of the wireless device 210-a according to an elapsed time (e.g., a quantity of clock cycles, or the like) between detecting the initial voltage and detecting the threshold transmission voltage.

A relatively low charging rate may indicate that the wireless device 210-a is located at a cell edge and may accordingly be out-of-coverage (e.g., out of coverage or out of range of the reader 205). In some examples, when the device determines (e.g., identifies, detects, or measures) a slow charge rate (e.g., EH state), it may determine to refrain from activating (e.g., enabling, or powering, among other examples) one or more hardware components to reduce a power consumption of the wireless device 210-a. For example, the wireless device 210-a may include one or more sensing capabilities (e.g., sensing temperature, humidity, atmospheric pressure, light intensity, or the like) via one or more sensors, and the wireless device 210-a may activate a subset of sensors associated with the sensing functions of the wireless device 210-a and may correspondingly refrain from activating a different subset of sensors based on the EH state or charging rate. The wireless device 210-a may further refrain from activating the different subset of sensors in accordance with maintaining a threshold power level such that the wireless device 210-a may utilize the energy associated with the threshold power level to respond to one or more D2R queries (e.g., queries from the reader 205, among other examples). In such examples, the wireless device 210-a may obtain data from the activated set of components.

Additionally, or alternatively, the wireless device 210-a may activate, refrain from activating, or both, one or more CPUs (e.g., processors of the wireless device 210-a) based on the charge rate. For example, the wireless device 210-a may, based on obtaining data from the activated set of components, perform additional processing on the set of data. For an example, the wireless device 210-a may format the data according to a reporting format, or the wireless device 210-a may perform one or more calculations (e.g., arithmetic operations, among other examples) on the set of data, such as calculating a maximum or minimum value of a set of sensor measurements, calculating an average sensor measurement value, or the like. Accordingly, the wireless device 210-a may activate one more CPUs in accordance with the charge rate of the wireless device 210-a to perform the additional processing functions.

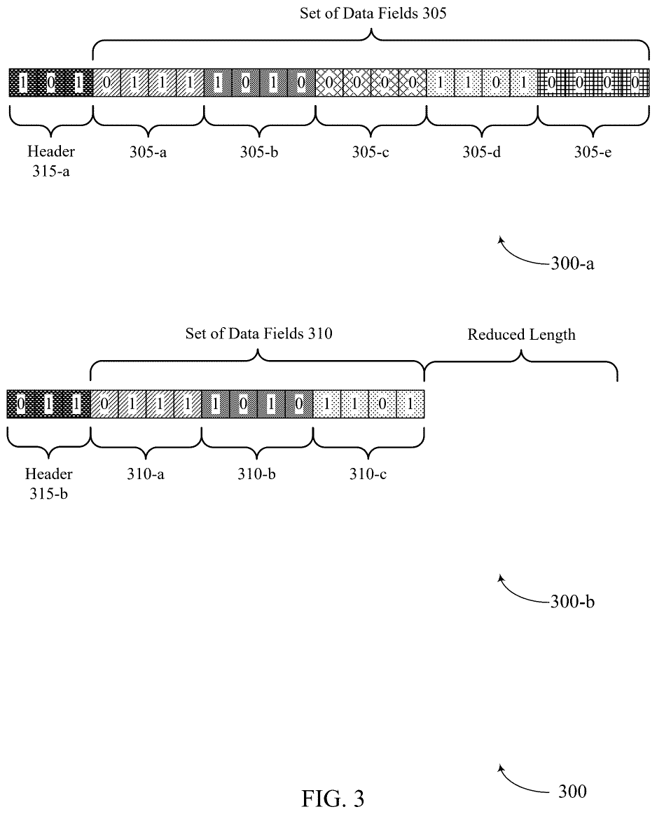

In some implementations, the wireless device 210-a may output a signal 225 (e.g., a reflected or backscattered signal, or a transmitted data signal such as a data packet, among other examples) according to one or more report formats, where the report format may be based on the charge rate. Example report formats are described in further detail elsewhere herein, including with reference to FIG. 3. For example, the wireless device 210-a may include one or more data fields within a data message of the signal 225 corresponding to the one or more activated components, one or more inactivated components, or both. That is, for example, the signal 225 may include an indication of sensor data corresponding to the activated sensors of the wireless device 210-a via one or more report formats.

In some implementations, the reader 205 may determine the charge rate of the wireless device 210-a (e.g., whether the charging rate is either high or low) based on obtaining the signal 225 (e.g., receiving the response from the wireless device 210-a). For example, the reader 205 may determine the charge rate of the wireless device 210-a based on identifying a report format of the data message of the signal 225. Additionally, or alternatively, the reader 205 may determine one or more data fields omitted from the signal 225 (e.g., missing data fields expected by the reader 205). That is, the wireless device 210-a may output the signal 225 according to one or more report formats associated with a low charge rate of the wireless device, among other examples, and the reader 205 may correspondingly detect the report format and identify that the wireless device 210-a is in a low EH state (e.g., associated with the low charge rate). Additionally, or alternatively, the signal 225 may include an indication (e.g., an explicit indication) of the charge rate of the wireless device 210-a (e.g., whether the charge rate is low, high, or the like).

In such examples, the reader 205 may increase a signal power associated with the energy signaling and may output second energy signaling 230 according to the increased power. For example, the wireless device 210-a may increase a transmission power of the second energy signaling 230 (e.g., via signal amplification, or the like). In some examples, a network component (e.g., a network commander, or network operator, among other examples) may enable one or more continuous wave transmitters, which may increase a signal power of the second energy signaling 230. Additionally, or alternatively, the wireless device 210-a may increase the signal power of the second energy signaling 230 by increasing a duration (e.g., a charging duration) of the second energy signaling 230, a symbol duration of the second energy signaling 230, or the like. In such examples, the wireless device 210-a may charge for a relatively longer duration (e.g., at a same signal power, among other examples), which may enable the wireless device 210-a to attain a relatively greater power level compared to the energy signaling 220 (e.g., corresponding to an initial signal duration).

In some examples, the wireless device 210-a may activate a greater quantity of sensors (e.g., compared to an initial quantity of sensors associated with a relatively lower power level) based on obtaining the second energy signaling 230 and based on attaining the greater power level, and may output the signal 225 (e.g., a repetition of the initial signal 225) including data fields associated with the greater quantity of sensors. Accordingly, the reader 205 may obtain the signal 225 including sensor data associated with the greater quantity of activated components of the reader 205 (e.g., a complete set of data, or a relatively more complete set of data, among other examples).

FIG. 3 shows examples of message formats 300 that support energy-dependent payload for EH communications payload for EH communications in accordance with one or more aspects of the present disclosure. Aspects of the message formats 300 may implement or be implemented by aspects of the wireless communications system 100, the wireless communications system 200, or both. For example, a message format 300-a, a message format 300-b, or both may be implemented by the reader 205, the wireless device 210-a, or both. In some examples, the reader 205 may be an example of the network entity 105, among other examples.

In some implementations, a wireless device (e.g., an A-IoT device, or tag device, among other examples) may output a D2R response message based on a D2R query (e.g., a reflected or backscattered signal, or a transmitted data signal such as a data packet, among other examples). For example, the D2R response may be based on the message format 300-a, the message format 300-b, or other examples of report formats. The message format 300-a and the message format 300-b may include a set of data fields 305 and a set of data fields 310, respectively to be included in a D2R response. In some examples, the content (e.g., data content) of the D2R response may vary based on a charge rate (e.g., charge rate, EH state, or the like) of the wireless device, further described herein with reference to FIG. 2. That is, the content of the D2R response message may vary based on a set of activated components (e.g., sensors), a set of inactivated sensors, or both based on the charge rate.

In some examples, the D2R response may be formatted according to the message format 300-a, which may represent a fixed length response. That is, the D2R response may include the set of data fields 305, where each field of the set of data fields 305 is associated with a respective component of the wireless device, and each field of the set of data fields 305 is included within the D2R response irrespective of whether one or more of the components are inactivated (e.g., and data associated with the component is correspondingly unavailable). In such examples, one or more fields of the set of data fields 305 may be associated with a respective inactivated component (e.g., skipped fields). Accordingly, the one or more fields of the set of data fields 305 may include dummy data as the content of the skipped field (e.g., skipped senor data). The dummy data may include one or more invalid patterns (e.g., invalid bit patterns), such as all zeros, all ones, or any combination thereof.

As an example, the set of data fields 305 illustrated in FIG. 3 may include at least a data field 305-a, a data field 305-b, a data field 305-c, a data field 305-d, and a data field 305-e, where each data field of the set of data fields 305 may be associated with a respective device component (e.g., sensor, or the like). For example, the data field 305-a, the data field 305-b, and the data field 305-d may each be associated with a respective activated component (e.g., in accordance with the charge rate of the wireless device), and the data field 305-c and the data field 305-e may each be associated with a respective inactivated device (e.g., in accordance with the charge rate). As such, the wireless device may include dummy data (e.g., all zeroes, or the like) within the data field 305-c, the data field 305-e, or both indicating that the components (e.g., sensors) associated with the data field 305-c and the data field 305-e are inactivated, and data associated with the sensors is unavailable. The wireless device may additionally include valid data (e.g., sensor data associated with activated components). within the data field 305-a, the data field 305-b, the data field 305-d, or any combination thereof.

Additionally, or alternatively, the set of data fields 305 may include an indication via a header 315-a (e.g., a message header, or one or more data bits of the header message, among other examples). The header 315-a may indicate (e.g., explicitly indicate) which fields of the set of data fields 305 include valid data. That is, the wireless device may indicate the valid data fields of the D2R response included within the set of data fields 305 via one or more invalid bit patterns associated with the inactivated components, an explicit indication (e.g., via the header 315-a), or both.

In some other examples, the D2R response may be formatted according to the message format 300-b, which may represent a variable length response. That is, the D2R response may include the set of data fields 310, where each field of the set of data fields 310 is associated with a respective activated component of the wireless device. In such examples, each field of the set of data fields 310 may correspond to sensor data associated with the one or more activated components (e.g., sensors), and the wireless device may refrain from including one or more skipped fields associated with one or more inactivated components within the set of data fields 310. Accordingly, a D2R message based on the message format 300-b may include a relatively shorter payload length compared to a corresponding D2R message based on the message format 300-a (e.g., based on an absence of the skipped fields, or skipped contents).

For an example, the set of data fields 310 may include at least a data field 310-a, a data field 310-b, and a data field 310-c, where each data field of the set of data fields 310 may be associated with a respective device component (e.g., sensor, or the like). For example, the data field 310-a, the data field 310-b, and the data field 310-c may each be associated with a respective activated component (e.g., in accordance with the charge rate of the wireless device), and the data included within the data field 310-a, the data field 310-b, and the data field 310-c may be valid data (e.g., sensor data associated with activated components). In such examples, the set of data fields 310 may include an indication via a header 315-b, which may indicate (e.g., explicitly indicate) a set of data fields (e.g., skipped data fields) absent from the set of data fields 310. That is, the header 315-b may indicate one or more sets of data associated with one or more inactivated components of the set of wireless device components that are absent from the D2R report such that a reader device may identify which sets of sensor data may be unavailable, among other examples.

The wireless device may output a D2R response message based on the message format 300-a, the message format 300-b, or the like in accordance with the charge rate of the wireless device.

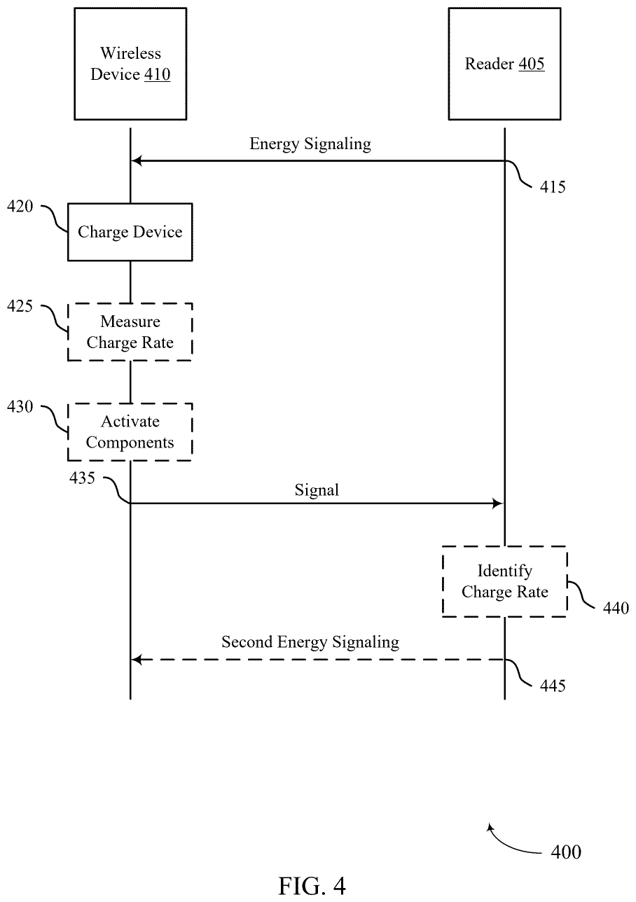

FIG. 4 shows an example of a process flow 400 that supports energy-dependent payload for EH communications payload for EH communications in accordance with one or more aspects of the present disclosure. Aspects of the process flow 400 may implement or be implemented by aspects of the wireless communications system 100, the wireless communications system 200, or both. For example, the process flow 400 may include a reader 405 and a wireless device 410, which may be examples of the reader 205 and the wireless device 210-a respectively. In some examples, the reader 405 may be an example of the network entity 105, or the like.

In the following description of the process flow 400, the operations between the reader 405 and the wireless device 410 may be performed in different orders or at different times. Some operations may also be left out of the process flow 400, or other operations may be added. Although the reader 405 and the wireless device 410 are shown performing the operations of the process flow 400, some aspects of some operations may also be performed by one or more other wireless devices.

At 415, the reader 405 may output, and the wireless device 410 may obtain, energy signaling (e.g., an initial signal, or an incident signal, among other examples). The energy signaling may include a quantity of energy such that the wireless device 410 may harvest the energy to power the wireless device 410, including one or more components of the wireless device 410 such as sensors, among other examples. The reader 405 may output the energy signaling in accordance with an EH operation.

At 420, the wireless device 410 may, based on obtaining the energy signaling of 415 and in accordance with harvesting the energy of the energy signaling, charge the wireless device 410. In some examples, charging wireless device 410 may be associated with increasing a voltage level associated with a power level of the wireless device 410.

At 425, the wireless device 410 may determine a charge rate (e.g., an EH rate, or the like) of the wireless device 410. For example, the wireless device 410 may determine (e.g., measure or identify) a charging duration according to one or more techniques further described herein with reference to FIG. 2. In some examples, determining the charge rate of the wireless device 410 may be based on measuring the voltage level of the wireless device 410.

At 430, the wireless device 410 may activate a first subset of components (e.g., sensors, or the like) of the wireless device 410 in accordance with the charge rate. Additionally, or alternatively, the wireless device 410 may refrain from activating (e.g., enabling, or powering, among other examples) a second subset of components in accordance with the determined charge rate. The first subset of components, the second subset of components, or both may include one or more sensors, one or more CPUs, or the like. Accordingly, the wireless device 410 may obtain data (e.g., measurement information, or the like) from at least the first subset of components (e.g., the activated subset of components). Additionally, or alternatively, the wireless device 410 may perform additional processing on the data utilizing the one or more activated CPUs in accordance with the charge rate of the wireless device 410.

At 435, the wireless device 410 may output, and the reader 405 may obtain, a signal (e.g., via backscattered modulation, or the like). The signal may be a reflected or backscattered signal, or a transmitted data signal such as a data packet, among other examples. In some examples, the wireless device 410 may output the signal in response to the energy signaling of 415. The signal may include one or more different types of data in accordance with the charge rate of the wireless device, where the one or more different types of data correspond to the first subset and the second subset of components (e.g., activated and inactivated device components of the wireless device 410). Accordingly, the wireless device 410 may output signal may according to one or more report formats further described herein with reference to FIG. 3.

For example, the signal may include a fixed set of data fields associated with each component of the wireless device 410 (e.g., both activated and inactivated components of the wireless device 410). In such examples, one or more fields associated with the second subset of components (e.g., inactivated components) may include dummy data, which may indicate (e.g., to the reader 405, or the like) that the data field is associated with an inactive component, and that the data associated with the component is correspondingly unavailable. Additionally, or alternatively, a header message included within the signal may indicate which fields of the set of data fields include data associated with inactivated components (e.g., invalid data).

In some other examples, the signal may include a variable set of data fields, where each data field of the set of data fields is associated with a respective activated component of the wireless device 410. That is, the signal includes the data associated with the first subset of components. Additionally, or alternatively, a header message included within the signal may indicate a subset of data fields associated with inactivated components (e.g., skipped data fields) that are absent from (e.g., not included within) the variable set of data fields of the signal.

At 440, the reader 405 may, based on obtaining the signal, and according to one or more techniques further described herein with reference to FIG. 2, determine (e.g., identify, or detect, among other examples) the charge rate of the wireless device 410. For example, the reader 405 may determine the charge rate of the wireless device 410 based on a message format of the signal. In some examples, the reader 405 may determine that the charge rate of the wireless device 410 is relatively low, and may, at 445, output second energy signaling corresponding to a greater reception power (e.g., received power at the wireless device 410). For example, the reader 405 may output the second energy signaling according to one or more techniques further described herein with reference to FIG. 2 and corresponding to a greater transmission power, a greater signal duration, a continuous waveform, or the like.

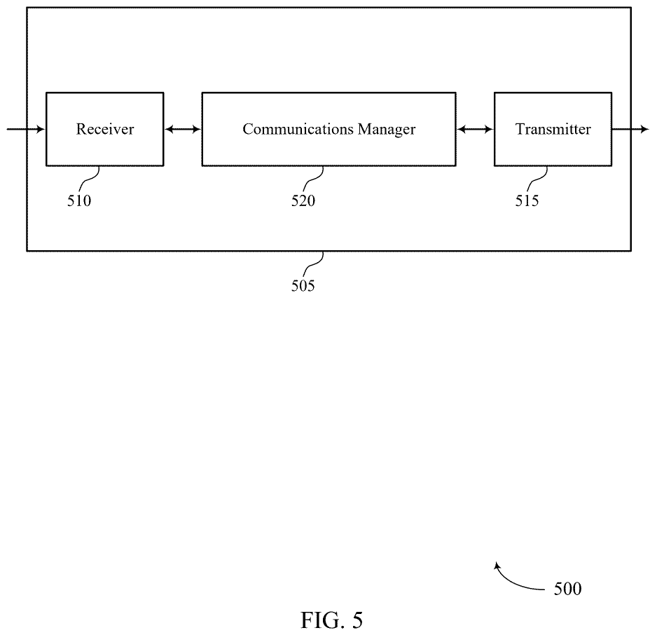

FIG. 5 shows a block diagram 500 of a device 505 that supports energy-dependent payload for EH communications payload for EH communications in accordance with one or more aspects of the present disclosure. The device 505 may be an example of aspects of a wireless device as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to energy-dependent payload for EH communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to energy-dependent payload for EH communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of energy-dependent payload for EH communications payload for EH communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for obtaining energy signaling associated with charging the wireless device in accordance with an EH operation. The communications manager 520 is capable of, configured to, or operable to support a means for charging, in accordance with the energy signaling and the EH operation, the wireless device according to a charge rate of the wireless device. The communications manager 520 is capable of, configured to, or operable to support a means for outputting a signal in response to the energy signaling, where the signal includes one or more different types of data in accordance with the charge rate of the wireless device.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for, reduced power consumption and more efficient utilization of communication resources, among other benefits.

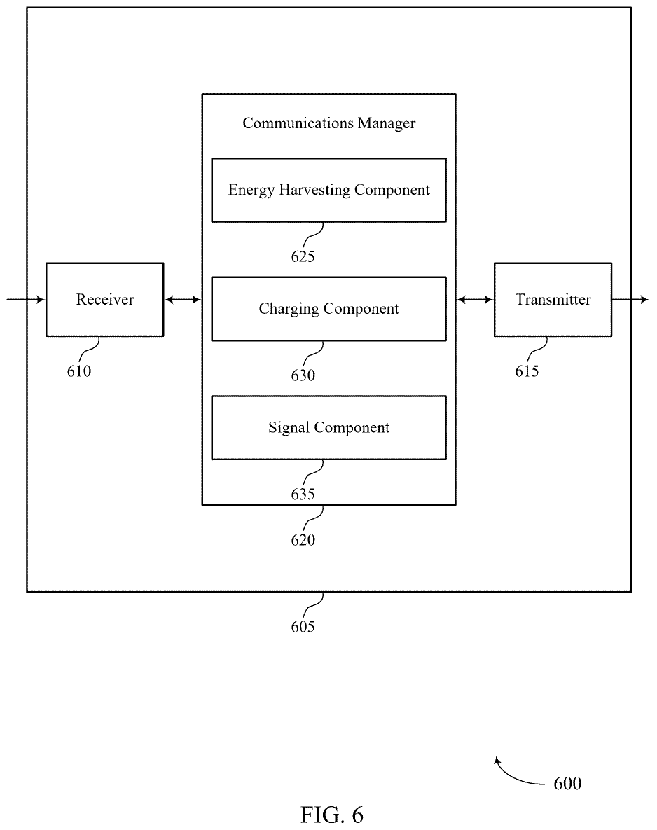

FIG. 6 shows a block diagram 600 of a device 605 that supports energy-dependent payload for EH communications payload for EH communications in accordance with one or more aspects of the present disclosure. The device 605 may be an example of aspects of a device 505 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to energy-dependent payload for EH communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to energy-dependent payload for EH communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of energy-dependent payload for EH communications payload for EH communications as described herein. For example, the communications manager 620 may include an energy harvesting component 625, a charging component 630, a signal component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The energy harvesting component 625 is capable of, configured to, or operable to support a means for obtaining energy signaling associated with charging the wireless device in accordance with an EH operation. The charging component 630 is capable of, configured to, or operable to support a means for charging, in accordance with the energy signaling and the EH operation, the wireless device according to a charge rate of the wireless device. The signal component 635 is capable of, configured to, or operable to support a means for outputting a signal in response to the energy signaling, where the signal includes one or more different types of data in accordance with the charge rate of the wireless device.

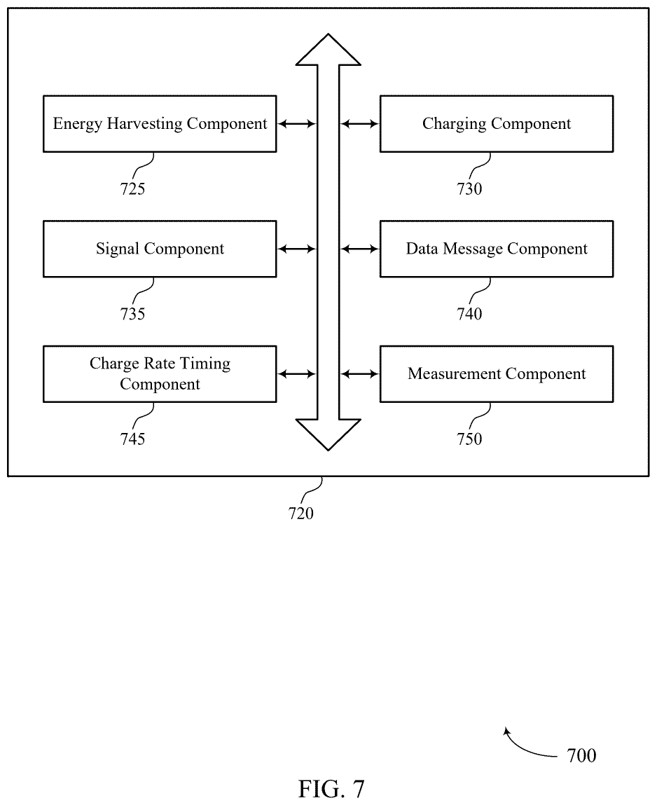

FIG. 7 shows a block diagram 700 of a communications manager 720 that supports energy-dependent payload for EH communications payload for EH communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of energy-dependent payload for EH communications payload for EH communications as described herein. For example, the communications manager 720 may include an energy harvesting component 725, a charging component 730, a signal component 735, a data message component 740, a charge rate timing component 745, a measurement component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The energy harvesting component 725 is capable of, configured to, or operable to support a means for obtaining energy signaling associated with charging the wireless device in accordance with an EH operation. The charging component 730 is capable of, configured to, or operable to support a means for charging, in accordance with the energy signaling and the EH operation, the wireless device according to a charge rate of the wireless device. The signal component 735 is capable of, configured to, or operable to support a means for outputting a signal in response to the energy signaling, where the signal includes one or more different types of data in accordance with the charge rate of the wireless device.

In some examples, to support outputting the signal, the data message component 740 is capable of, configured to, or operable to support a means for outputting, via one or more first fields of a set of multiple fields included in the signal, a first type of data of the one or more different types of data included in the signal, where the first type of data includes measurement information associated with one or more first components of the wireless device after the charging according to the charge rate. In some examples, to support outputting the signal, the data message component 740 is capable of, configured to, or operable to support a means for outputting, via one or more second fields of the set of multiple fields in the signal, a second type of data of the one or more different types of data included in the signal, where the second type of data includes dummy data in accordance with a state of one or more second components of the wireless device after the charging according to the charge rate.

In some examples, the charge rate timing component 745 is capable of, configured to, or operable to support a means for activating the one or more first components in accordance with the charge rate of the wireless device. In some examples, the measurement component 750 is capable of, configured to, or operable to support a means for obtaining, by the one or more first components in accordance with the activating, the measurement information, where outputting the first type of data via the signal is in accordance with obtaining the measurement information.

In some examples, to support outputting the second type of data, the data message component 740 is capable of, configured to, or operable to support a means for outputting, via the one or more second fields of the set of multiple fields in the signal, one or more bit patterns that indicate the one or more second fields include the dummy data.

In some examples, to support outputting the signal, the data message component 740 is capable of, configured to, or operable to support a means for outputting, via the signal, an indication of a position of the one or more first fields including the first type of data.

In some examples, a length of the signal includes a fixed length irrespective of an amount of data included in the one or more different types of data in the signal, the fixed length including the one or more first fields and the one or more second fields.

In some examples, to support outputting the signal, the data message component 740 is capable of, configured to, or operable to support a means for outputting, via a header included within the signal, an indication of one or more first fields that are included in the signal. In some examples, to support outputting the signal, the data message component 740 is capable of, configured to, or operable to support a means for outputting, via the one or more first fields included in the signal, a first type of data of the one or more different types of data included in the signal, where the first type of data includes measurement information associated with one or more first components of the wireless device after the charging according to the charge rate.

In some examples, the charge rate timing component 745 is capable of, configured to, or operable to support a means for activating the one or more first components in accordance with the charge rate of the wireless device. In some examples, the measurement component 750 is capable of, configured to, or operable to support a means for obtaining, by the one or more first components in accordance with the activating, the measurement information, where outputting the first type of data via the one or more first fields included in the signal is in accordance with obtaining the measurement information, and where a quantity of data fields included within the signal in accordance with the charge rate.

In some examples, the indication of the one or more first fields further indicates an absence of one or more second fields in accordance with one or more second components of the wireless device that are unpowered after the charging according to the charge rate.

In some examples, the energy harvesting component 725 is capable of, configured to, or operable to support a means for receiving second energy signaling after outputting the signal, where the one or more different types of data included in the signal indicate the charge rate of the wireless device, and where a second transmission power of the second energy signaling is greater than a first transmission power of the energy signaling based on the charge rate of the wireless device.

In some examples, the charge rate timing component 745 is capable of, configured to, or operable to support a means for measuring, after initiating the charging of the wireless device, a voltage associated with the wireless device in accordance with the energy signaling. In some examples, the charge rate timing component 745 is capable of, configured to, or operable to support a means for initializing a timer in accordance with the measured voltage satisfying a first threshold. In some examples, the charge rate timing component 745 is capable of, configured to, or operable to support a means for stopping the timer in accordance with the measured voltage satisfying a second threshold, the second threshold corresponding to a threshold transmission voltage for the wireless device, where the charge rate of the wireless device corresponds to an elapsed time of the timer.

In some examples, the one or more different types of data include one or more different types of sensor data associated with one or more sense components of the wireless device.

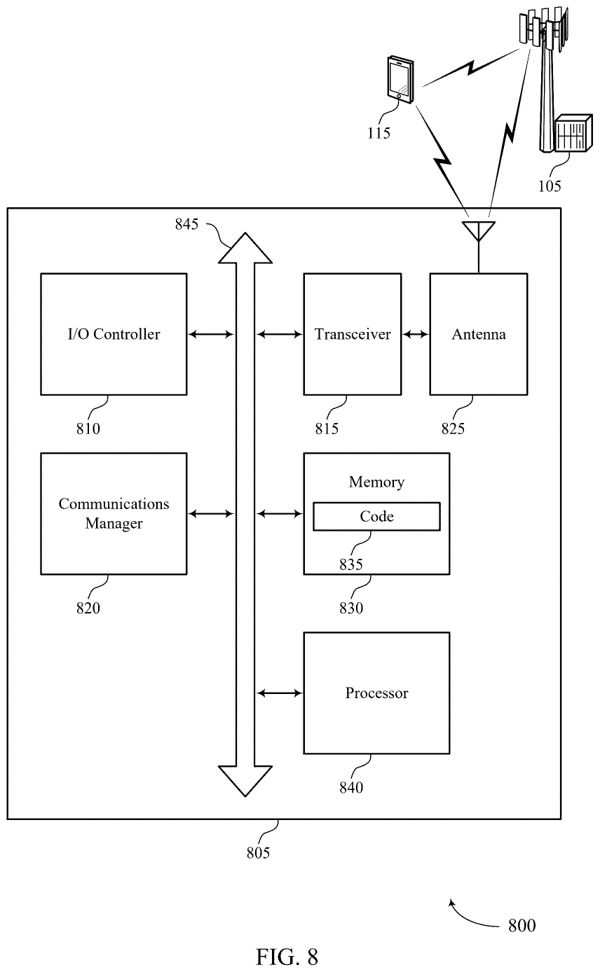

FIG. 8 shows a diagram of a system 800 including a device 805 that supports energy-dependent payload for EH communications payload for EH communications in accordance with one or more aspects of the present disclosure. The device 805 may be an example of or include components of a device 505, a device 605, or a wireless device as described herein. The device 805 may include components for bi-directional voice and data communications including components for transmitting and receiving communications, such as a communications manager 820, an I/O controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include RAM and ROM. The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a BIOS which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting energy-dependent payload for EH communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for obtaining energy signaling associated with charging the wireless device in accordance with an EH operation. The communications manager 820 is capable of, configured to, or operable to support a means for charging, in accordance with the energy signaling and the EH operation, the wireless device according to a charge rate of the wireless device. The communications manager 820 is capable of, configured to, or operable to support a means for outputting a signal in response to the energy signaling, where the signal includes one or more different types of data in accordance with the charge rate of the wireless device.

By including or configuring the communications manager 820 in accordance with examples as described herein, the device 805 may support techniques for improved communication reliability, reduced power consumption, more efficient utilization of communication resources, improved coordination between devices, and improved utilization of processing capability, among other benefits.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of energy-dependent payload for EH communications payload for EH communications as described herein, or the at least one processor 840 and the at least one memory 830 may be otherwise configured to, individually or collectively, perform or support such operations.

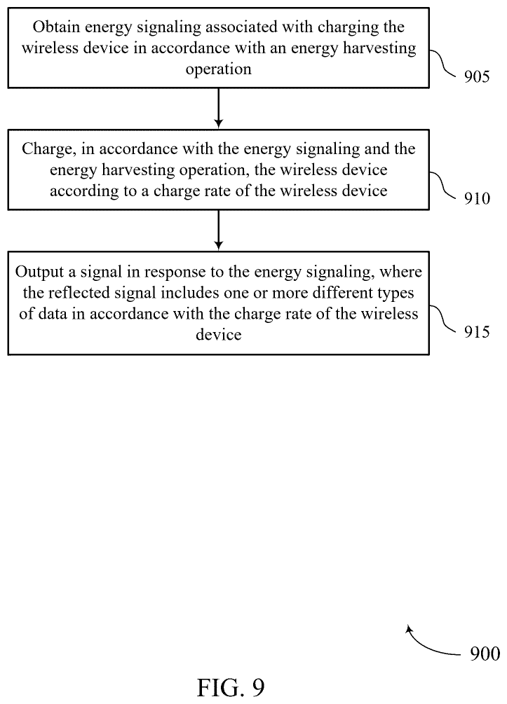

FIG. 9 shows a flowchart illustrating a method 900 that supports energy-dependent payload for EH communications payload for EH communications in accordance with one or more aspects of the present disclosure. The operations of the method 900 may be implemented by a wireless device or its components as described herein. For example, the operations of the method 900 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 905, the method may include obtaining energy signaling associated with charging the wireless device in accordance with an EH operation. The operations of 905 may be performed in accordance with examples as disclosed herein. In some examples, aspects of the operations of 905 may be performed by an energy harvesting component 725 as described with reference to FIG. 7.

At 910, the method may include charging, in accordance with the energy signaling and the EH operation, the wireless device according to a charge rate of the wireless device. The operations of 910 may be performed in accordance with examples as disclosed herein. In some examples, aspects of the operations of 910 may be performed by a charging component 730 as described with reference to FIG. 7.

At 915, the method may include outputting a signal in response to the energy signaling, where the signal includes one or more different types of data in accordance with the charge rate of the wireless device. The operations of 915 may be performed in accordance with examples as disclosed herein. In some examples, aspects of the operations of 915 may be performed by a signal component 735 as described with reference to FIG. 7.

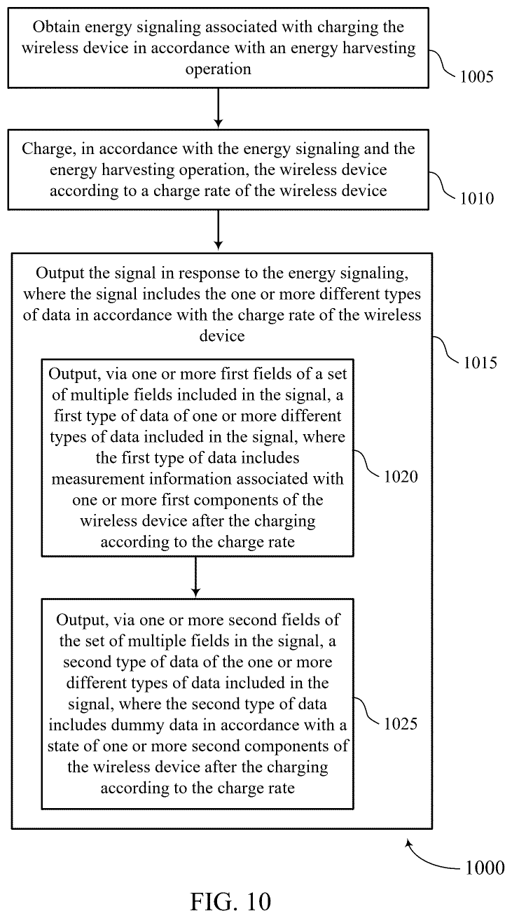

FIG. 10 shows a flowchart illustrating a method 1000 that supports energy-dependent payload for EH communications payload for EH communications in accordance with one or more aspects of the present disclosure. The operations of the method 1000 may be implemented by a wireless device or its components as described herein. For example, the operations of the method 1000 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1005, the method may include obtaining energy signaling associated with charging the wireless device in accordance with an EH operation. The operations of 1005 may be performed in accordance with examples as disclosed herein. In some examples, aspects of the operations of 1005 may be performed by an energy harvesting component 725 as described with reference to FIG. 7.

At 1010, the method may include charging, in accordance with the energy signaling and the EH operation, the wireless device according to a charge rate of the wireless device. The operations of 1010 may be performed in accordance with examples as disclosed herein. In some examples, aspects of the operations of 1010 may be performed by a charging component 730 as described with reference to FIG. 7.

At 1015, the method may include outputting a signal in response to the energy signaling, where the signal includes one or more different types of data in accordance with the charge rate of the wireless device. The operations of 1015 may be performed in accordance with examples as disclosed herein. In some examples, aspects of the operations of 1015 may be performed by a signal component 735 as described with reference to FIG. 7.

At 1020, outputting the signal may include outputting, via one or more first fields of a set of multiple fields included in the signal, a first type of data of one or more different types of data included in the signal, where the first type of data includes measurement information associated with one or more first components of the wireless device after the charging according to the charge rate. The operations of 1020 may be performed in accordance with examples as disclosed herein. In some examples, aspects of the operations of 1020 may be performed by a data message component 740 as described with reference to FIG. 7.

, At 1025, the outputting the signal may further include outputting, via one or more second fields of the set of multiple fields in the signal, a second type of data of the one or more different types of data included in the signal, where the second type of data includes dummy data in accordance with a state of one or more second components of the wireless device after the charging according to the charge rate. The operations of 1025 may be performed in accordance with examples as disclosed herein. In some examples, aspects of the operations of 1025 may be performed by a data message component 740 as described with reference to FIG. 7.

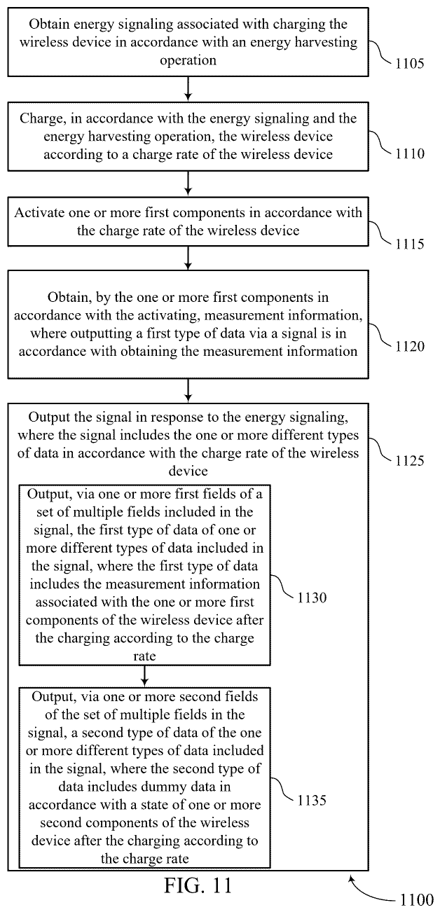

FIG. 11 shows a flowchart illustrating a method 1100 that supports energy-dependent payload for EH communications payload for EH communications in accordance with one or more aspects of the present disclosure. The operations of the method 1100 may be implemented by a wireless device or its components as described herein. For example, the operations of the method 1100 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 1105, the method may include obtaining energy signaling associated with charging the wireless device in accordance with an EH operation. The operations of 1105 may be performed in accordance with examples as disclosed herein. In some examples, aspects of the operations of 1105 may be performed by an energy harvesting component 725 as described with reference to FIG. 7.

At 1110, the method may include charging, in accordance with the energy signaling and the EH operation, the wireless device according to a charge rate of the wireless device. The operations of 1110 may be performed in accordance with examples as disclosed herein. In some examples, aspects of the operations of 1110 may be performed by a charging component 730 as described with reference to FIG. 7.

At 1115, the method may include activating one or more first components in accordance with the charge rate of the wireless device. The operations of 1115 may be performed in accordance with examples as disclosed herein. In some examples, aspects of the operations of 1115 may be performed by a charge rate timing component 745 as described with reference to FIG. 7.

At 1120, the method may include obtaining, by the one or more first components in accordance with the activating, measurement information, where outputting a first type of data via a signal is in accordance with obtaining the measurement information. The operations of 1120 may be performed in accordance with examples as disclosed herein. In some examples, aspects of the operations of 1120 may be performed by a measurement component 750 as described with reference to FIG. 7.

At 1125, the method may include outputting the signal in response to the energy signaling, where the signal includes the one or more different types of data in accordance with the charge rate of the wireless device. The operations of 1125 may be performed in accordance with examples as disclosed herein. In some examples, aspects of the operations of 1125 may be performed by a signal component 735 as described with reference to FIG. 7.

At 1130, outputting the signal may include outputting, via one or more first fields of a set of multiple fields included in the signal, the first type of data of one or more different types of data included in the signal, where the first type of data includes the measurement information associated with the one or more first components of the wireless device after the charging according to the charge rate. The operations of 1130 may be performed in accordance with examples as disclosed herein. In some examples, aspects of the operations of 1130 may be performed by a data message component 740 as described with reference to FIG. 7.

At 1135, outputting the signal may include outputting, via one or more second fields of the set of multiple fields in the signal, a second type of data of the one or more different types of data included in the signal, where the second type of data includes dummy data in accordance with a state of one or more second components of the wireless device after the charging according to the charge rate. The operations of 1135 may be performed in accordance with examples as disclosed herein. In some examples, aspects of the operations of 1135 may be performed by a data message component 740 as described with reference to FIG. 7.

The following provides an overview of aspects of the present disclosure:

Aspect 1: A method for wireless communications by a wireless device, comprising: obtaining energy signaling associated with charging the wireless device in accordance with an EH operation; charging, in accordance with the energy signaling and the EH operation, the wireless device according to a charge rate of the wireless device; and outputting a reflected signal in response to the energy signaling, wherein the reflected signal comprises one or more different types of data in accordance with the charge rate of the wireless device.

Aspect 2: The method of aspect 1, wherein outputting the reflected signal further comprises: outputting, via one or more first fields of a plurality of fields included in the reflected signal, a first type of data of the one or more different types of data included in the reflected signal, wherein the first type of data comprises measurement information associated with one or more first components of the wireless device after the charging according to the charge rate; and outputting, via one or more second fields of the plurality of fields in the reflected signal, a second type of data of the one or more different types of data included in the reflected signal, wherein the second type of data comprises dummy data in accordance with a state of one or more second components of the wireless device after the charging according to the charge rate.

Aspect 3: The method of aspect 2, further comprising: activating the one or more first components in accordance with the charge rate of the wireless device; and obtaining, by the one or more first components in accordance with the activating, the measurement information, wherein outputting the first type of data via the reflected signal is in accordance with obtaining the measurement information.

Aspect 4: The method of any of aspects 2 through 3, wherein outputting the second type of data further comprises: outputting, via the one or more second fields of the plurality of fields in the reflected signal, one or more bit patterns that indicate the one or more second fields comprise the dummy data.

Aspect 5: The method of any of aspects 2 through 4, wherein outputting the reflected signal further comprises: outputting, via the reflected signal, an indication of a position of the one or more first fields comprising the first type of data.

Aspect 6: The method of any of aspects 2 through 5, wherein a length of the reflected signal comprises a fixed length irrespective of an amount of data included in the one or more different types of data in the reflected signal, the fixed length comprising the one or more first fields and the one or more second fields.

Aspect 7: The method of aspect 1, wherein outputting the reflected signal further comprises: outputting, via a header included within the reflected signal, an indication of one or more first fields that are included in the reflected signal; and outputting, via the one or more first fields included in the reflected signal, a first type of data of the one or more different types of data included in the reflected signal, wherein the first type of data comprises measurement information associated with one or more first components of the wireless device after the charging according to the charge rate.

Aspect 8: The method of aspect 7, further comprising: activating the one or more first components in accordance with the charge rate of the wireless device; and obtaining, by the one or more first components in accordance with the activating, the measurement information, wherein outputting the first type of data via the one or more first fields included in the reflected signal is in accordance with obtaining the measurement information, and wherein a quantity of data fields included within the reflected signal in accordance with the charge rate.

Aspect 9: The method of any of aspects 7 through 8, wherein the indication of the one or more first fields further indicates an absence of one or more second fields in accordance with one or more second components of the wireless device that are unpowered after the charging according to the charge rate.

Aspect 10: The method of any of aspects 1 through 9, further comprising: receiving second energy signaling after outputting the reflected signal, wherein the one or more different types of data included in the reflected signal indicate the charge rate of the wireless device, and wherein a second transmission power of the second energy signaling is greater than a first transmission power of the energy signaling based at least in part on the charge rate of the wireless device.

Aspect 11: The method of any of aspects 1 through 10, further comprising: measuring, after initiating the charging of the wireless device, a voltage associated with the wireless device in accordance with the energy signaling; initializing a timer in accordance with the measured voltage satisfying a first threshold; and stopping the timer in accordance with the measured voltage satisfying a second threshold, the second threshold corresponding to a threshold transmission voltage for the wireless device, wherein the charge rate of the wireless device corresponds to an elapsed time of the timer.

Aspect 12: The method of any of aspects 1 through 11, wherein the one or more different types of data comprise one or more different types of sensor data associated with one or more sense components of the wireless device.

Aspect 13: A wireless device for wireless communications, comprising one or more memories storing processor-executable code, and one or more processors coupled with the one or more memories and individually or collectively operable to execute the code to cause the wireless device to perform a method of any of aspects 1 through 12.

Aspect 14: A wireless device for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
obtain energy signaling associated with charging the wireless device in accordance with an energy harvesting operation;
charge, in accordance with the energy signaling and the energy harvesting operation, the wireless device according to a charge rate of the wireless device; and
output a signal in response to the energy signaling, wherein the signal comprises one or more different types of data in accordance with the charge rate of the wireless device.

2. The wireless device of claim 1, wherein, to output the signal, the one or more processors are individually or collectively further operable to execute the code to cause the wireless device to:
output, via one or more first fields of a plurality of fields included in the signal, a first type of data of the one or more different types of data included in the signal, wherein the first type of data comprises measurement information associated with one or more first components of the wireless device after the charging according to the charge rate; and
output, via one or more second fields of the plurality of fields in the signal, a second type of data of the one or more different types of data included in the signal, wherein the second type of data comprises dummy data in accordance with a state of one or more second components of the wireless device after the charging according to the charge rate.

3. The wireless device of claim 2, wherein the one or more processors are individually or collectively further operable to execute the code to cause the wireless device to:
activate the one or more first components in accordance with the charge rate of the wireless device; and
obtain, by the one or more first components in accordance with the activating, the measurement information, wherein outputting the first type of data via the signal is in accordance with obtaining the measurement information.

4. The wireless device of claim 2, wherein, to output the second type of data, the one or more processors are individually or collectively further operable to execute the code to cause the wireless device to:
output, via the one or more second fields of the plurality of fields in the signal, one or more bit patterns that indicate the one or more second fields comprise the dummy data.

5. The wireless device of claim 2, wherein, to output the signal, the one or more processors are individually or collectively further operable to execute the code to cause the wireless device to:
output, via the signal, an indication of a position of the one or more first fields comprising the first type of data.

6. The wireless device of claim 2, wherein a length of the signal comprises a fixed length irrespective of an amount of data included in the one or more different types of data in the signal, the fixed length comprising the one or more first fields and the one or more second fields.

7. The wireless device of claim 1, wherein, to output the signal, the one or more processors are individually or collectively further operable to execute the code to cause the wireless device to:
output, via a header included within the signal, an indication of one or more first fields that are included in the signal; and
output, via the one or more first fields included in the signal, a first type of data of the one or more different types of data included in the signal, wherein the first type of data comprises measurement information associated with one or more first components of the wireless device after the charging according to the charge rate.

8. The wireless device of claim 7, wherein the one or more processors are individually or collectively further operable to execute the code to cause the wireless device to:
activate the one or more first components in accordance with the charge rate of the wireless device; and
obtain, by the one or more first components in accordance with the activating, the measurement information, wherein outputting the first type of data via the one or more first fields included in the signal is in accordance with obtaining the measurement information, and wherein a quantity of data fields included within the signal in accordance with the charge rate.

9. The wireless device of claim 7, wherein the indication of the one or more first fields further indicates an absence of one or more second fields in accordance with one or more second components of the wireless device that are unpowered after the charging according to the charge rate.

10. The wireless device of claim 1, wherein the one or more processors are individually or collectively further operable to execute the code to cause the wireless device to:
receive second energy signaling after outputting the signal, wherein the one or more different types of data included in the signal indicate the charge rate of the wireless device, and wherein a second transmission power of the second energy signaling is greater than a first transmission power of the energy signaling based at least in part on the charge rate of the wireless device.

11. The wireless device of claim 1, wherein the one or more processors are individually or collectively further operable to execute the code to cause the wireless device to:
measure, after initiating the charging of the wireless device, a voltage associated with the wireless device in accordance with the energy signaling;
initialize a timer in accordance with the measured voltage satisfying a first threshold; and
stop the timer in accordance with the measured voltage satisfying a second threshold, the second threshold corresponding to a threshold transmission voltage for the wireless device, wherein the charge rate of the wireless device corresponds to an elapsed time of the timer.

12. The wireless device of claim 1, wherein the one or more different types of data comprise one or more different types of sensor data associated with one or more sense components of the wireless device.

13. A method for wireless communications by a wireless device, comprising:
obtaining energy signaling associated with charging the wireless device in accordance with an energy harvesting operation;
charging, in accordance with the energy signaling and the energy harvesting operation, the wireless device according to a charge rate of the wireless device; and
outputting a signal in response to the energy signaling, wherein the signal comprises one or more different types of data in accordance with the charge rate of the wireless device.

14. The method of claim 13, wherein outputting the signal further comprises:
outputting, via one or more first fields of a plurality of fields included in the signal, a first type of data of the one or more different types of data included in the signal, wherein the first type of data comprises measurement information associated with one or more first components of the wireless device after the charging according to the charge rate; and
outputting, via one or more second fields of the plurality of fields in the signal, a second type of data of the one or more different types of data included in the signal, wherein the second type of data comprises dummy data in accordance with a state of one or more second components of the wireless device after the charging according to the charge rate.

15. The method of claim 14, further comprising:
activating the one or more first components in accordance with the charge rate of the wireless device; and
obtaining, by the one or more first components in accordance with the activating, the measurement information, wherein outputting the first type of data via the signal is in accordance with obtaining the measurement information.

16. The method of claim 14, wherein outputting the second type of data further comprises:
outputting, via the one or more second fields of the plurality of fields in the signal, one or more bit patterns that indicate the one or more second fields comprise the dummy data.

17. The method of claim 14, wherein outputting the signal further comprises:
outputting, via the signal, an indication of a position of the one or more first fields comprising the first type of data.

18. The method of claim 14, wherein a length of the signal comprises a fixed length irrespective of an amount of data included in the one or more different types of data in the signal, the fixed length comprising the one or more first fields and the one or more second fields.

19. The method of claim 13, wherein outputting the signal further comprises:
outputting, via a header included within the signal, an indication of one or more first fields that are included in the signal; and
outputting, via the one or more first fields included in the signal, a first type of data of the one or more different types of data included in the signal, wherein the first type of data comprises measurement information associated with one or more first components of the wireless device after the charging according to the charge rate.

20. A wireless device for wireless communications, comprising:
means for obtaining energy signaling associated with charging the wireless device in accordance with an energy harvesting operation;
means for charging, in accordance with the energy signaling and the energy harvesting operation, the wireless device according to a charge rate of the wireless device; and
means for outputting a signal in response to the energy signaling, wherein the signal comprises one or more different types of data in accordance with the charge rate of the wireless device.
